(19) United States
(12) Patent Application Publication
(10) Pub. No.: US 2015/0065138 A1
(43) Pub. Date: Mar. 5, 2015

(54) FREQUENCY HANDOVER WITH INTER-FREQUENCY INTERFERENCE MEASUREMENT

(71) Applicant: QUALCOMM Incorporated, San Diego, CA (US)

(72) Inventors: Qingxin CHEN, Del Mar, CA (US); Ming YANG, San Diego, CA (US); Tom CHIN, San Diego, CA (US); Guangming SHI, San Diego, CA (US)

(21) Appl. No.: 14/471,962

(22) Filed: Aug. 28, 2014

Related U.S. Application Data
(60) Provisional application No. 61/872,438, filed on Aug. 30, 2013.

(51) Int. Cl. H04W 36/00

(52) U.S. Cl. CPC H04W 36/0094
USPC 455/436

(57) ABSTRACT

A method of wireless communication includes measuring interference to a primary frequency of a neighbor cell and measuring interference to at least one secondary frequency of the neighbor cell. The method also includes transmitting at least one measurement report based on the interference measurements of the primary frequency and the secondary frequency(ies).

### CROSS REFERENCE TO RELATED APPLICATIONS

The present application claims the benefit of U.S. Provisional Patent Application No. 61/872,438, filed on Aug. 30, 2013, in the names of Qingxin CHEN et al., the disclosure of which is expressly incorporated by reference herein in its entirety.

### TECHNICAL FIELD

Aspects of the present disclosure relate generally to wireless communication systems, and more particularly, to improving frequency handover with inter-frequency interference measurement.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes measuring interference to a primary frequency of a neighbor cell and measuring interference to one or more secondary frequency of the neighbor cell. The method also includes transmitting one or more measurement report based on the interference measurements of the primary frequency and the one or more secondary frequency.

Another aspect discloses a method of wireless communication. The method includes receiving one or more measurement report, from a user equipment (UE), based on interference measurements of a primary frequency and one or more secondary frequency of a neighbor cell. The method also includes initiating handover based on the received measurement report.

In another aspect, an apparatus for wireless communication is disclosed. The apparatus includes means for measuring interference to a primary frequency of a neighbor cell and means for measuring interference to one or more secondary frequency of the neighbor cell. The apparatus also includes means for transmitting one or more measurement report based on the interference measurements of the primary frequency and the one or more secondary frequency.

Another aspect discloses an apparatus for wireless communications including means for receiving one or more measurement report, from a UE, based on interference measurements of a primary frequency and one or more secondary frequency of a neighbor cell. The apparatus also includes means for initiating handover based on the received measurement report.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of measuring interference to a primary frequency of a neighbor cell and measuring interference to one or more secondary frequency of the neighbor cell. The program code also causes the processor(s) to transmit one or more measurement report based on the interference measurements of the primary frequency and the one or more secondary frequency.

Another aspect discloses a computer program product for wireless communications in a wireless network having a non-transitory computer-readable medium. The computer readable medium has non-transitory program code recorded thereon which, when executed by the processor(s), causes the processor(s) to perform operations of receiving one or more measurement report, from a UE, based on interference measurements of a primary frequency and one or more secondary frequency of a neighbor cell. The program code also causes the processor(s) to initiate handover based on the received measurement report.

In another aspect of the present disclosure, an apparatus for a wireless communication is disclosed. The apparatus has a memory and one or more processor(s) coupled to the memory. The processor(s) is configured to measure interference to a primary frequency of a neighbor cell and to measure interference to one or more secondary frequency of the neighbor cell. The processor(s) is also configured to transmit one or more measurement report based on the interference measurements of the primary frequency and the one or more secondary frequency.

Another aspect discloses a wireless communication apparatus having a memory and one or more processor(s) coupled to the memory. The processor(s) is configured to receive one or more measurement report, from a UE, based at least in part on interference measurements of a primary frequency and one or more secondary frequency of a neighbor cell. The processor(s) is also configured to initiate handover based on the received measurement report.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIGS. 5 and 6 are flow diagrams illustrating wireless communication methods for measuring interference according to aspects of the present disclosure.

FIG. 7 is a block diagram illustrating an example of a hardware implementation for an apparatus employing a processing system.

FIG. 8 is a block diagram illustrating an example of another hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

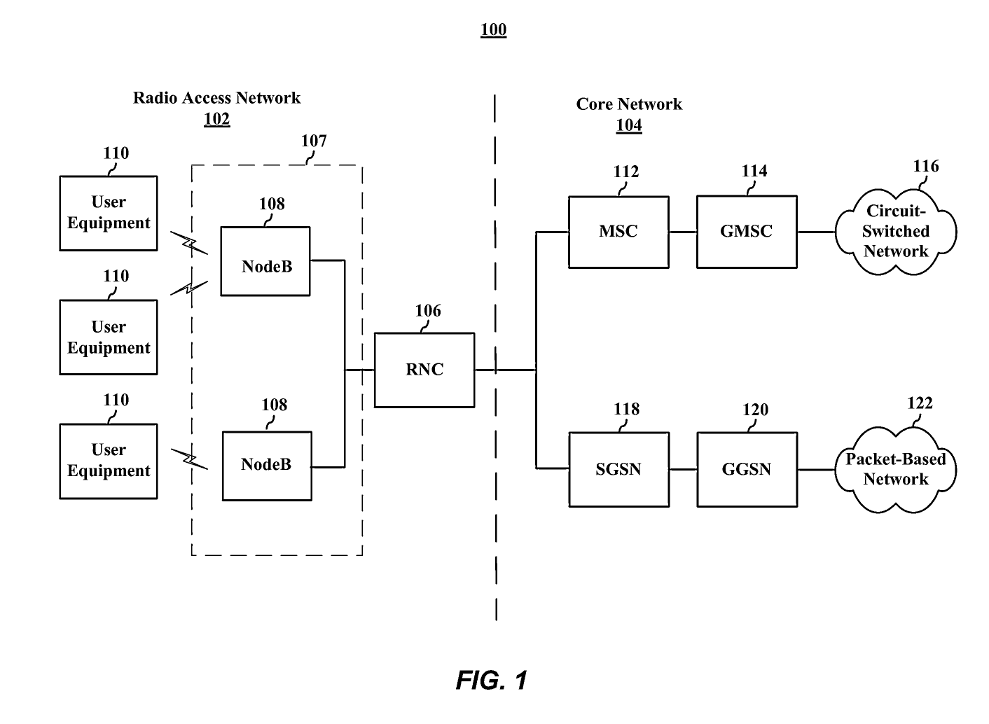

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving general packet radio service (GPRS) support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

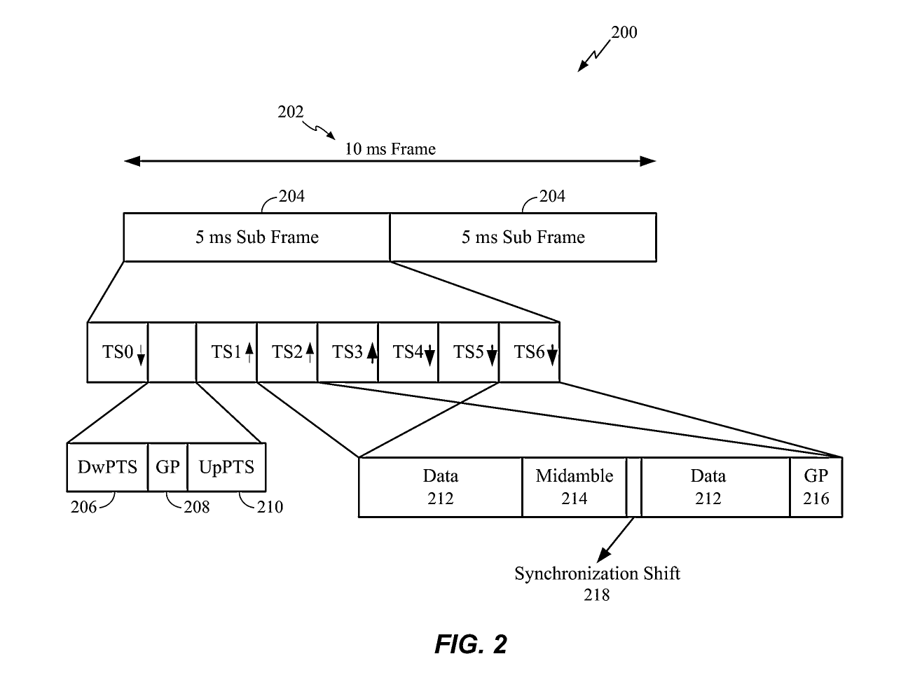

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

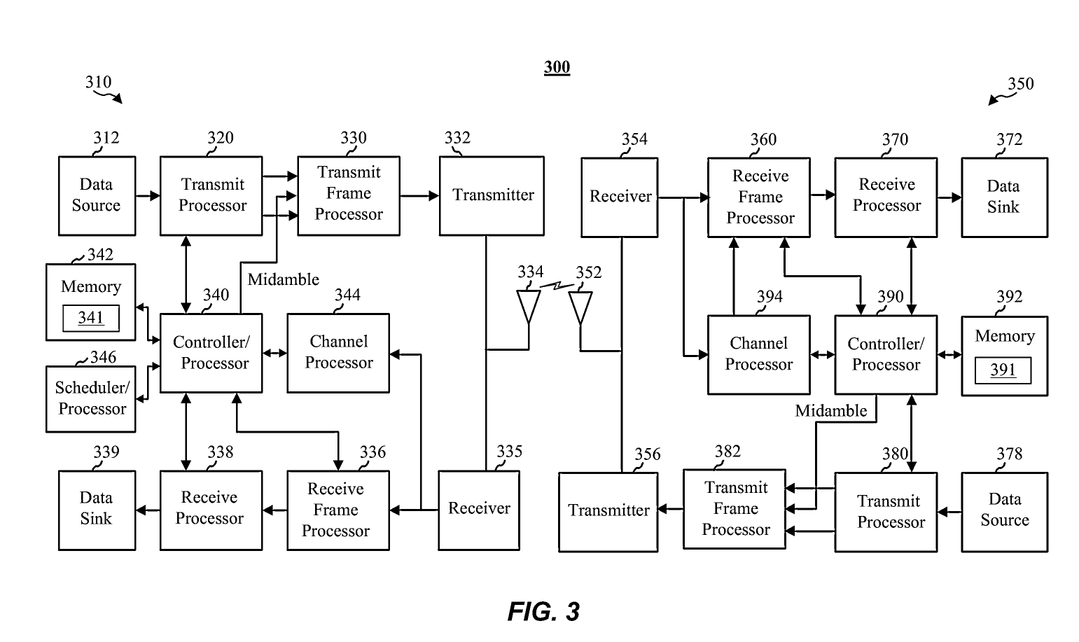

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store an interference measuring module 391 which, when executed by the controller/processor 390, configures the UE 350 to measure interference. Also, the memory 342 of the node B 310 may store an interference measurement receiving module 341 which, when executed by the controller/processor 340, configures the node B 310 to perform a method to receive interference measurements. A scheduler/processor 346 at the node B 310 may allocate resources to the UEs and schedule downlink and/or uplink transmissions for the UEs.

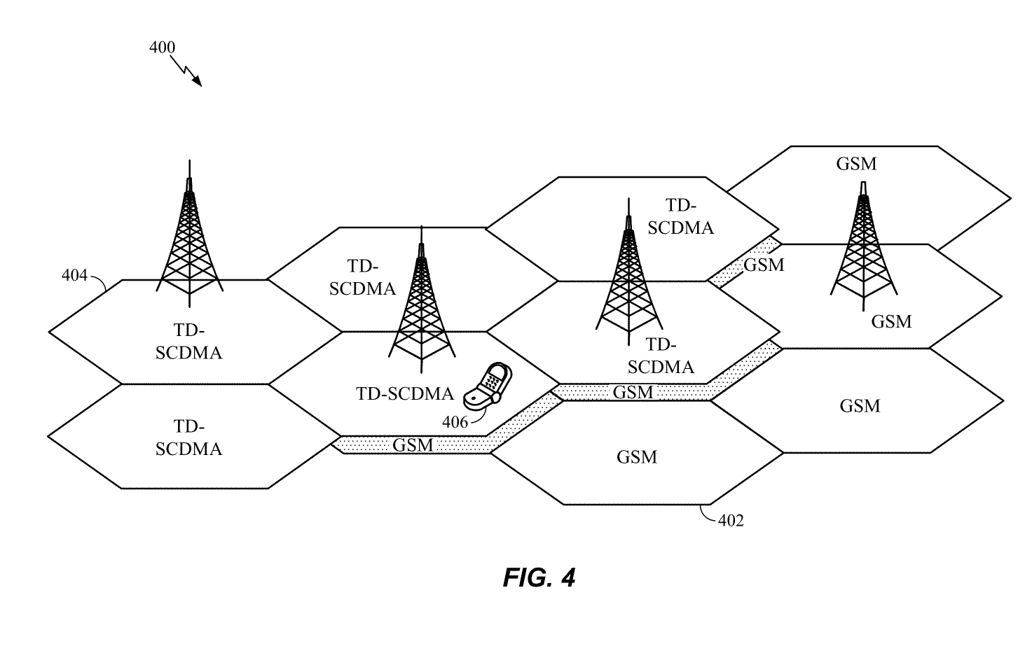

FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to identify/detect if any WiFi networks exist in the vicinity of the UE. In one configuration, the UE uses TD-SCDMA reception/transmission gaps to switch to the WiFi network to scan the WiFi channels.

Frequency Handover with Interference Measurement

Aspects of the present disclosure are directed to improving inter-frequency interference measurements for a handover to one of N frequencies of a radio access technology (RAT), such as time division-synchronous code division multiple access (TD-SCDMA). N may be a positive integer and represents the number of frequencies of a cell.

In some cases, UEs operating on a RAT, such as TD-SCDMA, may share the same radio bandwidth on a specific frequency. In one configuration, the bandwidth of each frequency of a RAT, such as TD-SCDMA, is 1.6 MHz operating at 1.28 Mega chips per second. Furthermore, in some RATs, such as TD-SCDMA, each cell may operate on multiple frequencies.

In a cell with multiple frequencies, one of the frequencies may be referred to as the primary frequency and the other frequencies may be referred to as the secondary frequencies. A beacon channel, such as the primary common control physical channel (P-CCPCH), may be transmitted on the first time slot, such as TS0, of the primary frequency. The beacon channel operates on the same frequency as a working frequency when the UE is in the dedicated channel state (CELL_DCH). The working frequency may be the primary frequency or one of the secondary frequencies.

When the UE is in a dedicated channel state, the UE may measure the received signal code power (RSCP) of a beacon channel of a neighbor cell. Based on the measured received signal code power, the UE may transmit a measurement report to trigger an inter-RAT or intra-RAT handover. That is, based on the measurement report, the base station may command the UE to perform the requested handover. In the present application the target cell may be referred to as the neighbor cell.

In a conventional network, the UE measures the interference of a primary frequency of one or more neighbor cells. The interference may be based on the interference signal code power (ISCP). That is, in the conventional network, the UE does not perform measurements of the secondary frequencies of the neighbor cell. Furthermore, in the conventional network, the UE only measures interference of the primary frequency when the primary frequency of a neighbor cell is the same as the working frequency of a serving cell. Additionally, or alternatively, in the conventional network, the UE does not measure and report the signal strength and/or interference on time slots other than the first time slot (TS0).

In some cases, it may be desirable to measure the primary frequency and/or the first time slot for a handover to single frequency RATs. Still, it may be undesirable to only measure the primary frequency and/or the first time slot for a handover to (or within) a multiple frequency RAT. That is, in some cases, for a multiple frequency RAT, the UE may experience interference after performing the handover because the UE did not measure and report the signal strength and/or interference on the secondary frequencies and/or other time slots. The interference may cause the UE to drop a call after the handover.

Aspects of the present disclosure are directed to improving handover measurements for multiple frequency RATs. Specifically, aspects of the present disclosure are directed to improving the capabilities of a UE to measure the interference of a neighbor cell. Such measurements are taken for secondary frequency information in neighbor lists transmitted by the network. All such measurements can be included in a measurement report transmitted by a UE. A UE with dual receive antennas can use the second antenna to tune to the other frequencies for measuring. The measurements can be on any time slot, not just TS0 (the first time slot).

In one configuration, the UE measures the interference of one or more frequencies of a neighbor cell, such as the primary frequency and secondary frequencies of the target cell. That is, the UE may measure all of the frequencies of a neighbor cell, a set of frequencies of the neighbor cell, or a specific frequency of the neighbor cell. Moreover, in the present configuration, the UE measures interference on a primary frequency and/or one or more secondary frequencies of the neighbor cell regardless of whether the measured frequency of the neighbor cell is the same as the working frequency of the serving cell. Thus, based on this configuration, the interference measurements of the target cell are improved.

According to another aspect of the present disclosure, the network includes information for the secondary frequencies of neighbor cells in the neighbor list information transmitted to a UE for a measurement report. Thus, in this configuration, the neighbor list includes information for all frequencies, such as the primary frequency and the secondary frequencies, of a cell.

As previously discussed, the network may be unaware of the received signal code power and/or interference of the secondary frequencies on neighbor cells. Therefore, a base station instructs a handover based only on the primary frequency information of a neighbor cell. Still, it is desirable for the base station to instruct a handover based on the primary frequency of a neighbor cell and one or more secondary frequencies of a neighbor cell.

According to an aspect of the present disclosure, the measurement reports include information for all frequencies measured on cells. The information may include the received signal code power of the measured frequencies and/or interference information, such as the interference signal code power, of the measured frequencies. In one configuration, the UE measures the interference on one or more downlink time slots of a secondary frequency of a neighbor cell to detect a level of interference on the secondary frequencies. Furthermore, the UE may transmit a measurement report to trigger a handover based on the measured interference and/or received signal code power of both the primary frequency and one or more secondary frequencies. Primary and secondary measurement reports may be transmitted. The base station can then select the best target frequency based on the received measurement reports. In another configuration, only a single measurement report is sent, including measurement for all frequencies/time slots.

According to another aspect of the present disclosure, the decision to transmit a measurement report may be based on both the received signal code power of a frequency and an amount of interference present on a frequency. Typically, the decision to send a measurement report is only based on a received signal code power, which corresponds to the distance between the UE and a neighbor base station. In contrast, interference is not based on the distance between the UE and the neighbor base station. Rather, the interference is based on the loading of the neighbor cell. The serving base station may combine the multi-frequency interference report with the received signal code power results to improve the handover decision.

As an example, a specific frequency, such as the primary frequency, may experience high amounts of interference due to a high number of UEs operating on the frequency even when a specific UE is in close proximity to the neighbor base station. Thus, in this example, the specific frequency may have a strong received signal code power and high levels of measured interference. Therefore, a handover to a target cell based only on the received signal code power may be undesirable if one or more of the frequencies of the target cell experience high levels of interference. Thus, the handover procedure may be improved if the UE also determines whether to transmit a measurement report based on both the received signal code power and the interference of the frequencies of a neighbor cell. More specifically, the UE also considers the measured interference of the target cell to prevent a handover to over-loaded cells.

In another example, a UE is served by a serving cell C0 with a working frequency F0. In this example, a first neighbor cell C1 operating on frequency F1 and a second neighbor cell C2 operating on frequency F2 are neighbor cells to the serving cell C0. The received signal code power strength of the first neighbor cell C1 is greater than the received signal code power strength of the second neighbor cell C2. Moreover, the received signal code power strength of the second neighbor cell C2 is greater than the received signal code power strength of the serving cell C0. However, the interference signal code power level of the second neighbor cell C2 is less than the interference signal code power level of the first neighbor cell C1. In this example, because the interference signal code power level of the second neighbor cell C2 is less than the interference signal code power level of the first neighbor cell C1, the UE may perform a handover to the second neighbor cell C2 instead of the first neighbor cell C1.

Furthermore, in some cases, some call types only operate on secondary frequencies. Therefore, a handover to a target cell with a strong signal strength for the primary frequency and low interference on the primary frequency may be undesirable if one or more of the secondary frequencies of the target cell experiences interference and/or has a low signal strength. Therefore, to prevent a handover to a target cell with undesirable conditions on one or more of the secondary frequencies, the UE does not transmit the measurement report when an amount of interference experienced on one or more secondary frequencies is greater than a threshold

In one configuration, the UE only includes the primary frequency information in the measurement report. Still, in this configuration, the UE determines whether to transmit the measurement report based on measurements of the amount of interference detected on both the primary frequency and one or more secondary frequencies. Specifically, the UE also measures an amount of interference present on the secondary frequencies to determine if the measured interference of the secondary frequencies is greater than a threshold. Thus, in this configuration, to prevent a handover to a weak target cell, such as a target cell with a high amount of measured interference or a low signal strength for one or more secondary frequencies, the UE does not transmit a measurement report if the measured interference of one or more of the secondary frequencies is greater than a threshold.

As previously discussed, the UE may consider interference measurement results of one or more frequencies of a neighbor cell when determining whether to transmit a measurement report. Still, in one configuration, the measurement report does not include the interference measurements and only includes the received signal code power of one or more measured frequencies.

According to another aspect of the present disclosure, a UE is configured with a dual-receive antenna, including a first antenna and a second antenna. The UE tunes to secondary frequencies with the second antenna for inter-frequency interference measurements. In another configuration, the UE has a single receive antenna that performs inter-frequency interference measurements during a dedicated measurement occasion (DMO) or a measurement gap. Inter-frequency interference may be measured by tuning to various frequencies of neighbor cells, such as secondary frequencies and the primary frequency.

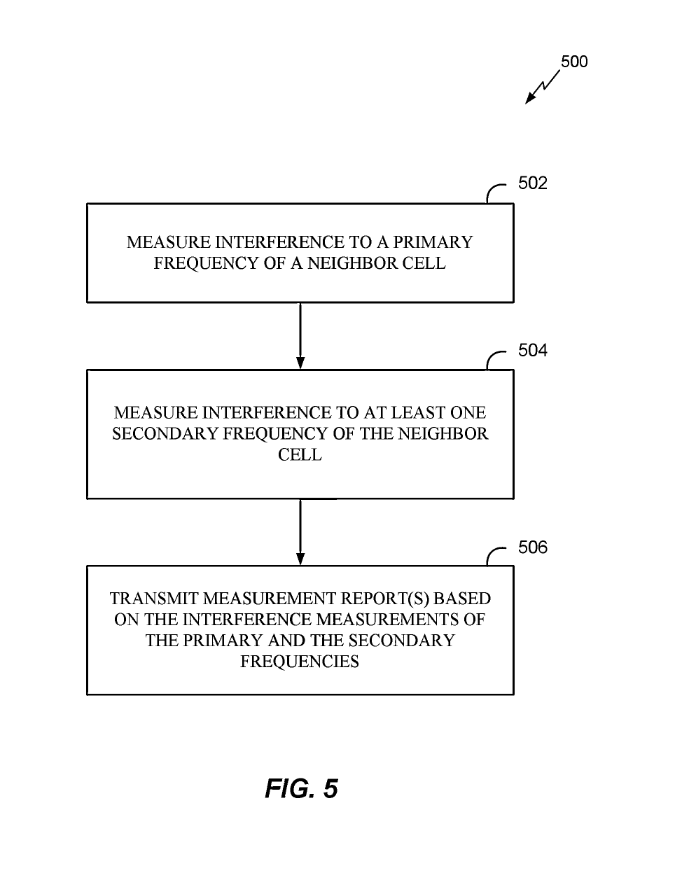

FIG. 5 is a flow diagram illustrating a wireless communication method 500 for measuring interference according to aspects of the present disclosure. In block 502, a user equipment (UE) measures interference to a primary frequency of a neighbor cell. In block 504, the UE measures interference to at least one secondary frequency of the neighbor cell. In block 506, the UE transmits at least one measurement report based on the interference measurements of the primary frequency and the at least one secondary frequency.

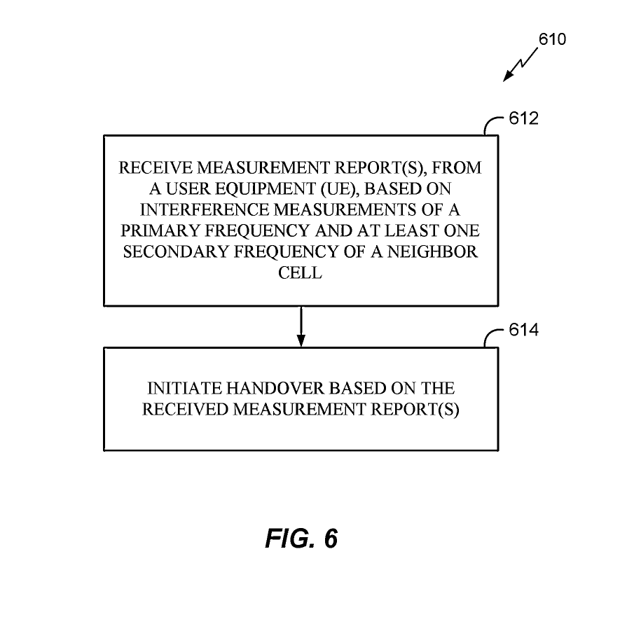

FIG. 6 is a flow diagram illustrating a wireless communication method 610 for receiving measured interference reports according to aspects of the present disclosure. In block 612, a base station receives a measurement report, from a UE, based on interference measurements of a primary frequency and at least one secondary frequency of a neighbor cell. In block 614, the base station initiates handover based on the received measurement report(s).

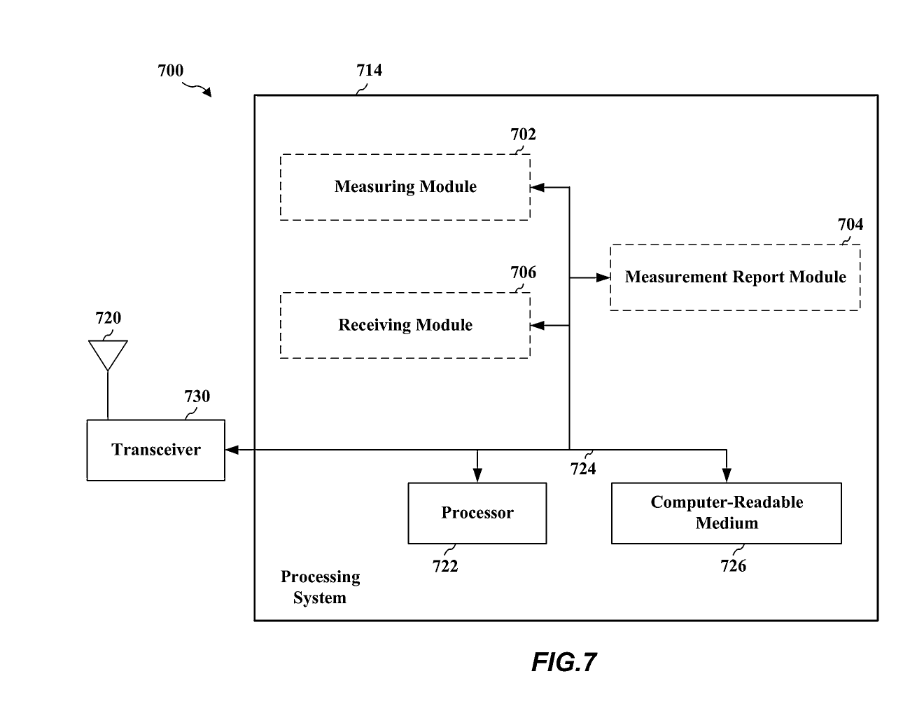

FIG. 7 is a block diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722, a measuring module 702, a measurement report module 704, a receiving module 706, and the computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a measuring module 702 for measuring interference to a primary frequency of a neighbor cell. The measuring module 702 may also be configured to measure interference to one or more secondary frequencies of the neighbor cell. As shown in FIG. 7, one measuring module 702 is specified for the processing system 714. Alternatively, separate measuring modules may be specified to measure the primary frequency and the one or more secondary frequencies. The processing system 714 also includes a measurement report module 704 for transmitting at least one measurement report based on the interference measurements of the primary and the secondary frequencies, transmitting the measurement report(s) based on the received neighbor list and transmitting the measurement report(s) based on the measured interference. The processing system 714 also includes a receiving module 706 for receiving a neighbor list including primary and secondary frequencies of neighbor cells. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as a UE 350 is configured for wireless communication includes means for measuring. In one aspect, the means for measuring may be the antennas 352, the receiver 354, the receive processor 370, the controller/processor 390, the memory 392, the interference measuring module 391, the measuring module 702, the processor 722, and/or the processing system 714 configured to perform the functions recited by the aforementioned means. In another aspect, the aforementioned means may be a module or any apparatus configured to perform the functions recited by the aforementioned means.

In one configuration, the apparatus configured for wireless communication also includes means for transmitting a measurement report. In one aspect, the means for transmitting may be the antennas 352, the transmitter 356, the transmit processor 380, the controller/processor 390, the memory 392, the interference measuring module 391, the measurement report module 704, the processor 722, and/or the processing system 714 configured to perform the functions recited by the aforementioned means. In another aspect, the aforementioned means may be any module or any apparatus configured to perform the functions recited by the aforementioned means.

In one configuration, the apparatus configured for wireless communication further includes means for receiving. In one aspect, the means may be the antennas 352, the receiver 354, the receive processor 370, the controller/processor 390, the memory 392, the interference measuring module 391, the receiving module 706, the processor 722, and/or the processing system 714 configured to perform the functions recited by the aforementioned means. In another aspect, the aforementioned means may be any module or any apparatus configured to perform the functions recited by the aforementioned means.

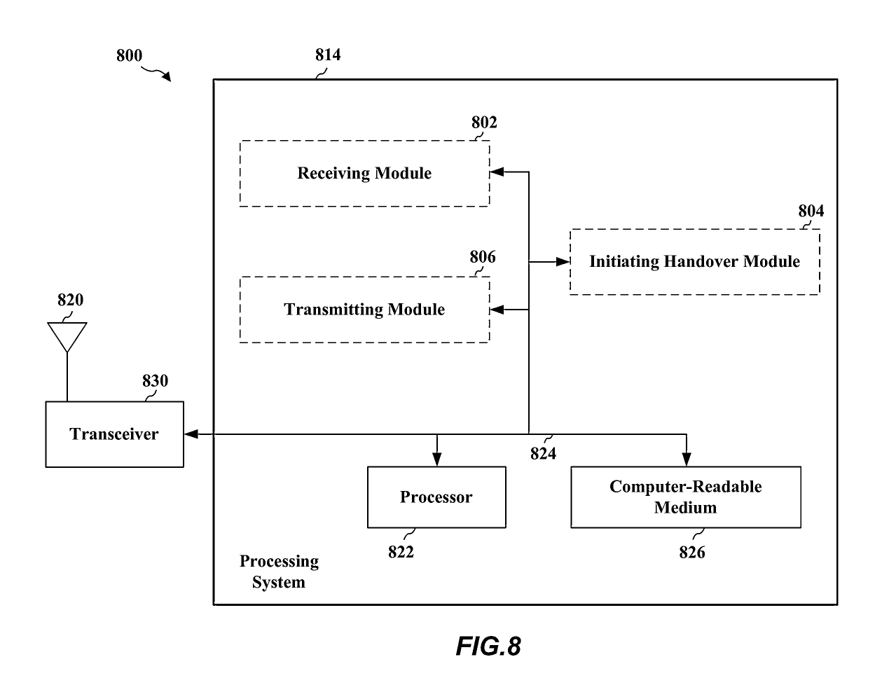

FIG. 8 is a block diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822, a receiving module 802, a handover initiating module 804, a transmitting module 806, and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a receiving module 802 for receiving at least one measurement report based on interference measurements of a primary frequency and at least one secondary frequency of a neighbor cell and receiving the measurement report(s) based on a transmitted neighbor list. The processing system 814 also includes a handover initiating module 804 for initiating handover based on the received measurement report(s). The processing system 814 also includes a transmitting module 806 for transmitting a neighbor list including a primary frequency and one or more secondary frequencies of neighbor cells. The modules may be software modules running in the processor 822, resident/stored in the computer-readable medium 826, one or more hardware modules coupled to the processor 822, or some combination thereof. The processing system 814 may be a component of a node B 310 and may include the memory 342, and/or the controller/processor 340.

In one configuration, an apparatus such as a node B 310 configured for wireless communication includes means for receiving. In one aspect, the receiving means may be the antennas 334, the receiver 335, the receive processor 338, the controller/processor 340, the memory 342, the interference measurement receiving module 341, the receiving module 802, the processor 822, and/or the processing system 814 configured to perform the functions recited by the aforementioned means. In another aspect, the aforementioned means may be any module or any apparatus configured to perform the functions recited by the aforementioned means.

In one configuration, the apparatus configured for wireless communication also includes means for initiating handover. In one aspect, the handover initiating means may be the antennas 334, the receiver 335, the receive processor 338, the transmitter 332, the transmit processor 320, the controller/processor 340, the memory 342, the interference measurement receiving module 341, the handover initiating module 804, the processor 822, and/or the processing system 814 configured to perform the functions recited by the aforementioned means. In another aspect, the aforementioned means may be any module or any apparatus configured to perform the functions recited by the aforementioned means.

In another configuration, the apparatus configured for wireless communication also includes means for transmitting. In one aspect, the transmitting means may be the antennas 334, the transmitter 332, the transmit processor 320, the controller/processor 340, the memory 342, the interference measurement receiving module 341, the transmitting module 806, the processor 822, and/or the processing system 814 configured to perform the functions recited by the aforementioned means. In another aspect, the aforementioned means may be any module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to GSM, as well as UMTS systems such as W-CDMA, High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
measuring interference to a primary frequency of a neighbor cell;
measuring interference to at least one secondary frequency of the neighbor cell; and
transmitting at least one measurement report based at least in part on the interference measurements of the primary frequency and the at least one secondary frequency.

2. The method of claim 1, in which the at least one measurement report indicates measured interference to each of the primary frequency and the at least one secondary frequency.

3. The method of claim 2, further comprising determining whether to send the at least one measurement report based at least in part on the measured interference to the primary frequency and the at least one secondary frequency.

4. The method of claim 3, in which the at least one measurement report is transmitted when the measured interference of the at least one secondary frequency is less than or equal to a threshold.

5. The method of claim 1, further comprising tuning at least one antenna to the primary frequency and the at least one secondary frequency.

6. The method of claim 1, further comprising receiving a neighbor list comprising the primary frequency and the at least one secondary frequency.

7. The method of claim 1, in which the primary frequency or the at least one secondary frequency is different than a working frequency of a serving cell.

8. The method of claim 1, in which the at least one measurement report comprises a first measurement report for the primary frequency and a second measurement report for the at least one secondary frequency.

9. A method of wireless communication, comprising:
receiving at least one measurement report, from a user equipment (UE), based at least in part on interference measurements of a primary frequency and at least one secondary frequency of a neighbor cell; and
initiating handover based on the received measurement report.

10. The method of claim 9, further comprising transmitting, to the UE, a neighbor list comprising the primary frequency and the at least one secondary frequency.

11. An apparatus for wireless communication, the apparatus comprising:
a memory unit; and
at least one processor coupled to the memory unit, the at least one processor being configured:
to measure interference to a primary frequency of a neighbor cell;
to measure interference to at least one secondary frequency of the neighbor cell; and
to transmit at least one measurement report based at least in part on the interference measurements of the primary frequency and the at least one secondary frequency.

12. The apparatus of claim 11, in which the at least one measurement report indicates measured interference to each of the primary frequency and the at least one secondary frequency.

13. The apparatus of claim 12, in which the at least one processor is further configured to determine whether to transmit the at least one measurement report based at least in part on the measured interference to the primary frequency and the at least one secondary frequency.

14. The apparatus of claim 13, in which the at least one processor is further configured to transmit the at least one measurement report when the measured interference of the at least one secondary frequency is less than or equal to a threshold.

15. The apparatus of claim 11, in which the at least one processor is further configured tune at least one antenna to the primary frequency and the at least one secondary frequency.

16. The apparatus of claim 11, in which the at least one processor is further configured to receive a neighbor list comprising the primary frequency and the at least one secondary frequency.

17. The apparatus of claim 11, in which the primary frequency or the at least one secondary frequency is different than a working frequency of a serving cell.

18. The apparatus of claim 11, in which the at least one measurement report comprises a first measurement report for the primary frequency and a second measurement report for the at least one secondary frequency.

19. An apparatus for wireless communication, the apparatus comprising:
a memory unit; and
at least one processor coupled to the memory unit, the at least one processor being configured:
to receive at least one measurement report, from a user equipment (UE), based at least in part on interference measurements of a primary frequency and at least one secondary frequency of a neighbor cell; and
to initiate handover based on the received measurement report.

20. The apparatus of claim 19, in which the at least one processor is further configured to transmit to the UE, a neighbor list comprising the primary frequency and the at least one secondary frequency.
